(19) United States
(12) Patent Application Publication
(10) Pub. No.: US 2002/0017427 A1
(43) Pub. Date: Feb. 14, 2002

(54) Fall restraint anchor

(76) Inventors: Richard M. Guenette, Edmonton (CA); Darrel Curilla, Edmonton (CA)

Correspondence Address: MSA, Mine Safety Appliances Company, P.O. Box 426, Pittsburgh, PA, 15230, US

(21) Appl. No.: 09/848,041

(22) Filed: May 3, 2001

(30) Foreign Application Priority Data
May 4, 2000 (CA) 2,307,536

(51) Int. Cl. A62B 1/16; A62B 35/00

(52) U.S. Cl. 182/3; 182/45

(57) ABSTRACT

A fall restraint anchor is disclosed which has an anchorage connector with a rail that can be secured to and pass about the anchor to allow a full 360° movement. A carriage is secured to the rail and a cable secured between the carriage and a worker. The device is particularly suitable for use on a tank with a vent to provide the anchor.

### FIELD OF THE INVENTION

The present invention relates to a fall restraint anchor and particularly to a fall restraint anchor which can easily be retrofitted for use on large cylindrical structures.

### BACKGROUND OF THE INVENTION

Fall restraints are used in construction and maintenance to provide security for workers operating at elevated locations. Typically they are in the form of a cable secured to some form of anchor at one end and to a harness worn by the worker at the opposite end. This provides a form of security to prevent the worker from inadvertently falling from the elevated location and being severely injured or killed.

Typically the fall restraint is anchored to a fixed point such as the ridge of a building or anchor points provided around the periphery of a building for attachment of a lifeline. Such an arrangement is typically used during construction of a structure or where frequent maintenance is anticipated thereby justifying a permanent installation. However, in certain environments, maintenance is much less frequent such that the provision of a permanent installation for a fall restraint is not justified or, has not been provided for in the design of the structure.

One such environment is found in storage tanks which generally are large cylindrical structures having a low pitched sloping or domed roof. These structures are carefully designed for structural integrity and do not lend themselves to retrofitting or subsequent adaptation for fall restraints. It would be desirable, therefore, to have a fall protection restraint for such structures which was easily retrofittable and which provided a full 360° of movement.

### SUMMARY OF THE INVENTION

According to one aspect of the present invention, there is provided a fall restraint anchor comprising an anchorage connector aving a rail circumnavigating the anchor, a carriage slidably mounted on the rail for 360° movement about the anchor, and a cable secured to the carriage. The cable is attachable to a worker to inhibit movement of the worker beyond a predetermined distance from the anchor.

According to a further aspect of the present invention, there is provided a fall restraint anchor for use on a large storage tank having a tubular vent structure upstanding from a roof of the tank. The fall restraint anchor includes a collar extending about the vent and secured thereto, an annular rail attached to the collar and circumnavigating the vent, a carriage mounted on the rail and a cable secured to the carriage and attachable to a worker to inhibit movement of the worker beyond the periphery of the roof of the tank.

Other details, objects and advantages of the present invention will become apparent as the following description of a presently preferred embodiment of practicing the invention proceeds.

### BRIEF DESCRIPTION OF THE DRAWINGS

A preferred embodiment of the present invention will now be described by way of example only with reference to the accompanying drawings wherein:

FIG. 1 is a side view partly in section of a representation of a storage tank;

FIG. 2 is an enlarged view of a portion of the storage tank shown in FIG. 1 on an enlarged scale.

FIG. 3 is a view on the line III-III of FIG. 2.

FIG. 4 is a plan view in the direction of arrow IV of the portion shown in FIG. 2; and

FIG. 5 is a side view of the portion shown in FIG. 4.

### DETAILED DESCRIPTION OF THE INVENTION

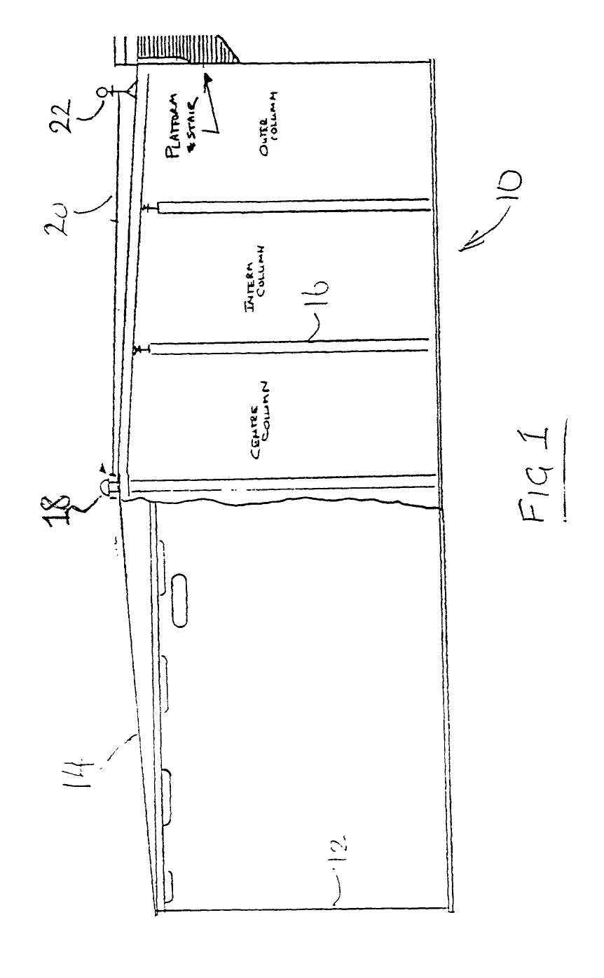

Referring to FIG. 1, a storage tank 10 has a side wall 12 and roof 14. The tank 10 is of circular cross-section and the roof 14 is elevated at its center to provide a conical surface. The roof 14 is supported at intervals at internal columns 16 and has a central vent 18 to accommodate expansion and alleviate pressure build-up within the tank 10. The construction of the tank 10 as described above is by way of example only and can follow any of a number of well-known designs utilized in the tank storage industry.

To provide security for a worker on the roof 14, a fall restraint system having a cable 20 is provided. As can be seen from FIG. 1, the cable 20 is secured at one end by a fall restraint anchor to the vent 18 and at the opposite end to a harness worn by the worker 22.

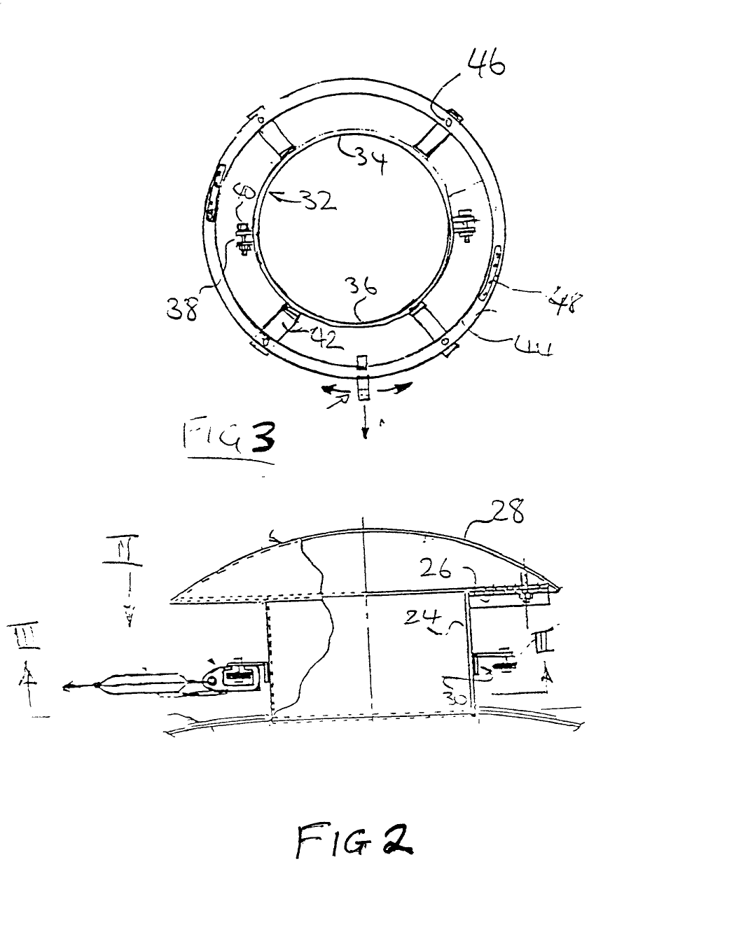

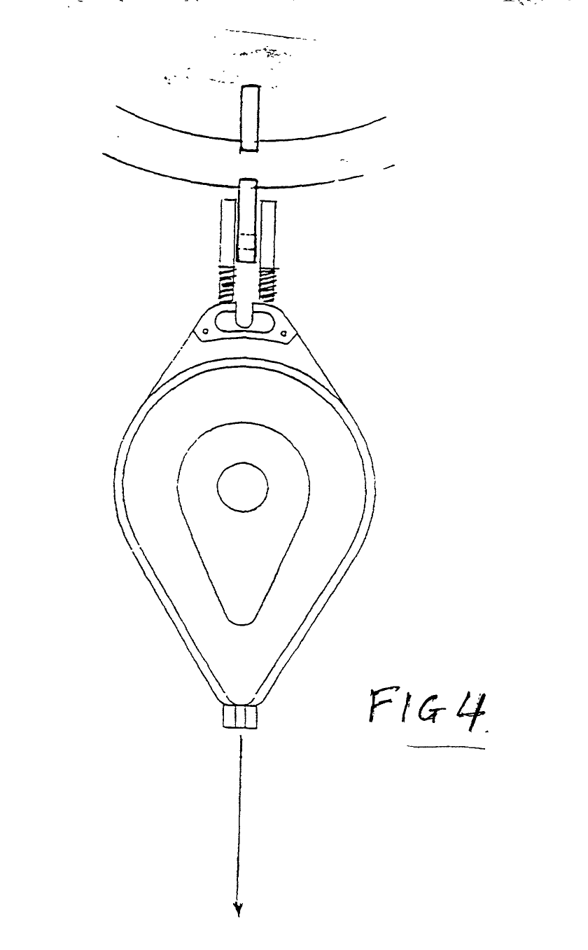

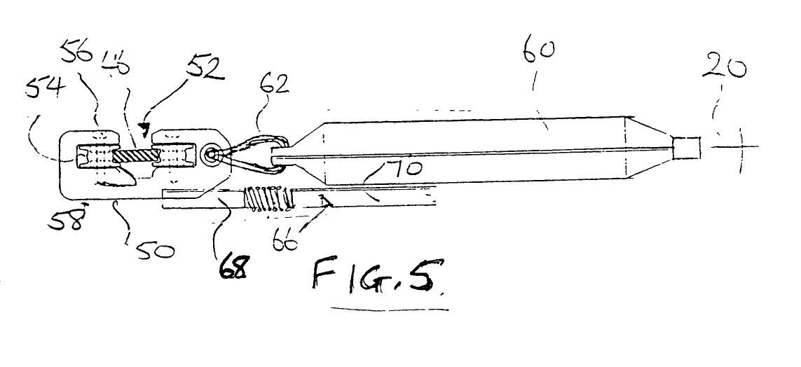

The fall restraint anchor is shown in more detail in FIGS. 2-5. Referring firstly to FIG. 2, the vent 18 typically includes a tubular body 24 with a radial flange 26 to which is secured a domed cap 28. A collar 30 is secured to the tubular body and comprises a band 32 formed into two semi-circular parts 34, 36 with radial tongues 38. The two parts 34, 36 are joined together by bolts 40 so that the band 32 can be snuggly secured against the outer surface of tubular body 24.

A plurality of radial spokes 42 extend from the band 32 to support an annular rail 44. The rail 44 is suspended below the spokes 42 on bolts 46 and is formed in two parts joined by splice plates 48. The plates 48 are received within recesses in the end of the rail to provide a smooth rail of substantially uniform thickness.

The rail 46 supports a carriage 50 that has a reentrant opening 52 to receive the rail 46. A pair of rollers 54 are located in the opening 52 and are positioned on opposite edges of the rail 46 to rotate on bolts 56. The rollers 54 have flanges 58 that overlay the peripheral edges of the rail 46 to hold the carriage snuggly on the rail.

A resilient coiling device 60 is secured to the carriage 50 through a universal joint formed by a wire loop 62. The coiling device 60 is of conventional construction and retracts cable 20 when tension is removed from the cable.

The coiling device 60 is maintained in a radial horizontal orientation by means of a pair of lost motion devices 66. Each of those devices includes a pair of abutments 68, 70 secured respectively to the carriage 50 and the restraint 60. A coil spring 72 is positioned between the abutments 68 and 70 and opposes downward movement of the restraint 60 toward the roof 14 of the tank 10.

In operation, the restraint can be secured to the vent 18 by assembly of the two parts 34, 36 around the wall and securing them to one another through bolts 40. The rail 46 may then be similarly placed about the wall 24 and the spliced plates 48 secured to provide the unitary annular rail.

The carriage 50 is free to move along the rail through 360° about the vent 18 and with the cable 20 secured to the worker 22 provides a restraint against inadvertent falling from the roof 14. As the worker 22 moves about the roof 14, the coiling device 60 retracts or plays out the cable 20 to maintain a minimum tension in the cable. Movement of the worker 22 circumferentially about the roof 14 is accommodated by the carriage 50 moving along the rail and maintaining the cable 20 directed radially toward the worker 22. The lost motion devices 66 maintain the restraint in a generally horizontal plane and accommodate vertical movements of the cable 20, depending upon the position of the worker. The restraint therefor ensures that the cable 20 is always positioned to provide a direct line of action to the worker and not encumber movement on the roof 14.

Upon completion of the maintenance, the cable may be removed and either stored within the coiling device secured to the restraint or, alternatively, the coiling device may be removed from the cradle. It will be noted that domed top 28 of the vent provides some protection for the rail from inclement weather thereby prolonging the service life of the fall restraint.

While a presently preferred embodiment of practicing the invention has been shown and described with particularity in connection with the accompanying drawing, the invention may otherwise be embodied within the scope of the following claims.

What is claimed is:

1. A fall restraint anchor comprising an anchorage connector, a rail circumnavigating the anchorage connector, a carriage slidably mounted on the rail for 360° movement about the anchor, and a cable secured to the carriage, the cable being attachable to a worker to inhibit movement of the worker beyond a predetermined distance from the anchor.

2. The fall restraint anchor according to claim 1 wherein the cable is secured to the carriage by a cable coiling device.

3. The fall restraint anchor according to claim 2 wherein the cable coiling device is pivotally connected to the carriage and is resiliently supported to project in a predetermined orientation relative to the anchor.

4. The fall restraint anchor according to claim 3 wherein a lost motion device is connected between the coiling device and the carriage.

5. The fall restraint anchor according to claim 4 wherein a pair of lost motion devices are provided to opposite sides of a pivotal connection to maintain the coiling device in the predetermined orientation.

6. The fall restraint anchor according to claim 1 wherein the anchorage connector comprises a collar to encompass a circular structure and a plurality of spokes extending radially from the collar to support the rail in spaced relationship from the circular structure.

7. The fall restraint anchor according to claim 6 wherein the collar is split into two parts to facilitate placement about the structure.

8. The fall restraint anchor according to claim 7 wherein the two parts are secured to one another by releasable fasteners to provide a snug engagement with the structure.

9. The fall restraint anchor according to claim 6 wherein the rail is offset from the spokes and the carriage includes a pair of rollers to engage radially inner and outer edges of the rail respectively.

10. The fall restraint anchor according to claim 9 wherein each of the rollers includes a pair of flanges to overlie peripheral edges of the rail.

11. The fall restraint anchor for use on a tank having a tubular vent structure, upstanding from a roof of the tank, the anchor including a collar extending about the vent and secured thereto, an annular rail attached to the collar and circumnavigating the vent, a carriage slidably mounted on the rail and a cable secured to the carriage and attachable to a worker to inhibit movement of the worker beyond the periphery of the roof.

12. The fall restraint anchor according to claim 11 wherein the cable is secured to the rail by a cable coiling device to maintain tension in the cable.

13. The fall restraint anchor according to claim 12 wherein the cable coiling device is maintained in a predetermined orientation relative to the roof.

14. The fall restraint anchor according to claim 13 wherein the collar is formed in two parts and the parts are connected to each other by releasable fasteners to secure the collar to the vent.

15. The fall restraint anchor according to claim 13 wherein a pair of lost motion devices are provided to maintain the coiling device in the predetermined orientation.

16. The fall restraint anchor according to claim 14 wherein the collar includes a plurality of spokes extending radially from the collar to support the rail in spaced relationship from the vent structure.

17. The fall restraint anchor according to claim 11 wherein the collar is split into two parts to facilitate placement about the vent structure.

18. The fall restraint anchor according to claim 17 wherein the two parts are secured to one another by releasable fasteners to provide a snug engagement with the vent structure.

19. The fall restraint anchor according to claim 16 wherein the rail is offset from the spokes and the carriage includes a pair of rollers to engage radially inner and outer edges of the rail respectively.

20. The fall restraint anchor according to claim 19 wherein each of the rollers includes a pair of flanges to overlie peripheral edges of the rail.
